(19) United States
(12) Patent Application Publication
(10) Pub. No.: US 2005/0124317 A1
(43) Pub. Date: Jun. 9, 2005

(54) System and method for wireless connectivity toolkit

(76) Inventor: Diego Kaplan, San Diego, CA (US)

Correspondence Address: Kyocera Wireless Corp., P. O. Box 928289, San Diego, CA, 92129-8289, US

(21) Appl. No.: 10/718,861

(22) Filed: Nov. 21, 2003

(51) Int. Cl. H04Q 7/20

(52) U.S. Cl. 455/411; 455/414.1; 455/418; 455/432.3

(57) ABSTRACT

A link between a handset and a connectivity toolkit program running on a server computer is established over a wireless communication network. The link can be initiated by the server computer via mobile IP or SMS request. The may also be initiated by the handset. Once the link is established, the connectivity toolkit program can send files to the handset and retrieve files from the handset. Correspondingly, the handset can send files to and retrieve files from the server. Thus, file storage can take place on either the server or the handset. For example, on the server, file storage can be managed by a database (DBMS) while on the handset, file storage can be managed by a local java applet.

### BACKGROUND

1. Field of the Invention

The present invention generally relates to wireless communications and more particularly relates to wireless connectivity toolkits available to wireless communication devices via a wireless communication network.

2. Related Art

Conventional connectivity toolkits require a stand alone program running on a computer with the handset connected to the computer via a specialized cable. FIG. 1 is a high level block diagram of a conventional stand alone connectivity toolkit 25. The stand alone toolkit 25 runs on a conventional personal computer (“PC”) and is connected to a wireless communication device 10 through a specialized cable. Typically, some sort of data storage area 30 is associated with the PC 20, for example a hard drive. The stand alone toolkit 25 is persistently stored in data storage are 30 along with information and data used by the stand alone toolkit 25.

There are a significant number of problems associated with this type of conventional connectivity toolkit. First and foremost, it requires that each wireless communication device owner also own a PC 20. Additionally, the wireless communication device owner must purchase the stand alone connectivity toolkit 25. Moreover, the wireless communication device owner must also purchase the specialized cable 15. Thus, this set up is very costly and poses a nearly insurmountable barrier to entry. Therefore, what is needed is a system and method that overcomes these significant problems found in the conventional systems as described above.

### SUMMARY

Accordingly, and as disclosed herein, the necessity of purchasing both the program and the cable can be eliminated and the user allowed to simply use a version of the connectivity toolkit running on a server accessible via a wireless communication network. Furthermore, users can store files on the server computer for a small fee, thus sparing the wireless communication device resources while providing user access to those files at any time via a file transfer utility available as part of the wireless connectivity toolkit. Additionally, the file storage ability allows carriers to increase their fee based revenue.

The link between a wireless communication device and a connectivity toolkit program running on a server computer is established over a wireless communication network. The link can be initiated by the server computer via mobile IP or SMS request. The link may also be initiated by the wireless communication device. Once the link is established, the connectivity toolkit program can send files to the wireless communication device and retrieve files from the wireless communication device. Correspondingly, the wireless communication device can send files to and retrieve files from the server. Thus, file storage can take place on either the server or the wireless communication device. For example, on the server, file storage can be managed by a database (DBMS) while on the wireless communication device, file storage can be managed by a local Java applet. Other utilities can also be provided as part of the connectivity toolkit.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is high level block diagram of a conventional stand alone connectivity toolkit;

FIG. 2 is a high level network diagram of a wireless connectivity system;

FIG. 3 is a block diagram of an example data storage area that can be used in a wireless connectivity toolkit system;

FIG. 4 is a flow diagram illustrating an example process for connecting to a wireless connectivity toolkit server via a wireless communication network;

FIG. 5 is a flow diagram illustrating an example process for obtaining a file list from a wireless connectivity toolkit server;

FIG. 6 is a flow diagram illustrating an example process for downloading a file from a wireless connectivity toolkit server;

FIG. 7 is a flow diagram illustrating an example process for uploading a file to a wireless connectivity toolkit server;

FIG. 8 is a block diagram illustrating an example wireless communication device as may be used in connection with various embodiments described herein; and

FIG. 9 is a block diagram illustrating an example computer system as may be used in connection with various embodiments described herein.

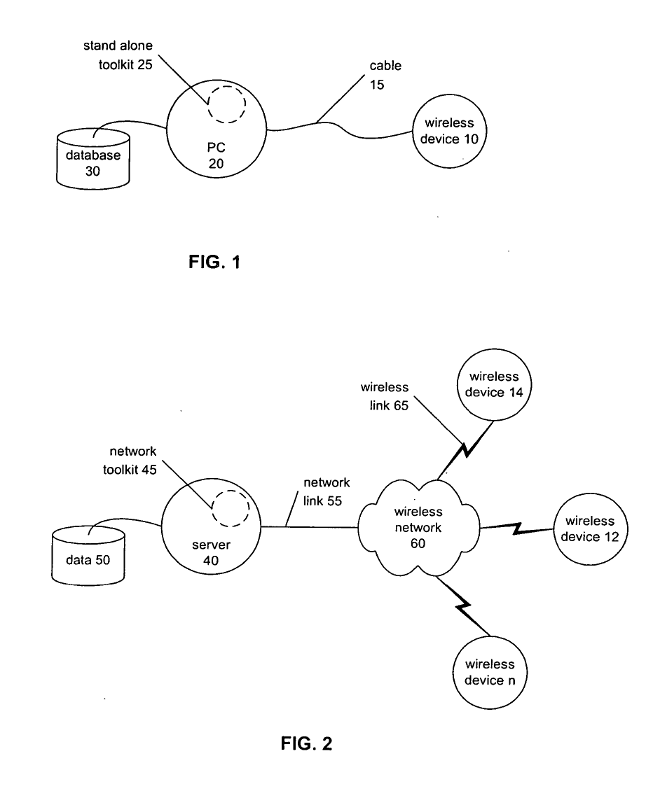

### DETAILED DESCRIPTION

Disclosed herein are systems and methods for a wireless connectivity toolkit. The wireless connectivity toolkit system includes a wireless connectivity toolkit server that provides a plurality of wireless, communication devices with a wireless connection to a connectivity toolkit that is executable on the server. One method disclosed herein allows for a wireless communication device to connect to the server via a wireless communication network and perform file maintenance in a data storage area associated with the wireless connectivity toolkit server.

In this detailed description, the term wireless connectivity toolkit server may be used interchangeably with “server.” “toolkit server,” “wireless server,” and “wireless toolkit server.” Similarly, the term wireless communication device may be used interchangeably with “handset,” “wireless device,” and “wireless handset.”

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

FIG. 2 is a high level network diagram of a wireless connectivity system. The system comprises a plurality of handsets (12, 14, and n) that are connected to a wireless toolkit server 40 via a wireless communication network 60. The various handsets preferably connect to the wireless network 60 via a wireless link 65. The toolkit server 40 is preferably connected to the wireless communication network 60 via a network link 55. Additionally, the toolkit server 40 preferably has access to a data storage area such as database 50. Finally, the toolkit server 40 has a network toolkit 45 comprising a computer program that is capable of execution on the toolkit server 40.

Handsets 12, 14 and n can be of any variety of wireless communication device, including cell phones, personal digital assistants (“PDAs”), laptop computers, handheld computers, tablet computers, and the like. The general characteristics of a wireless communication device such as handset 12 are that the wireless device be mobile and capable of a data connection with a wireless communication network 60 via a wireless link 65. In the illustrated embodiment, handset n is shown to emphasize that more than three handsets can be present in the wireless connectivity system.

Wireless communication network 60 preferably includes a plurality of base stations that are configured to establish a wireless link 65 with a handset. Additionally, wireless communication network 60 preferably includes wired network facilities including bridges and routers that enable the network 60 to establish a network link 55 with the toolkit server 40.

Wireless connectivity toolkit server 40 can be implemented on a general purpose computer or a special purpose computer constructed to optimize connectivity and performance of the toolkit server 40. The server 40 preferably has a data storage area such as database 50 for volatile and persistent storage of information such as computer files and executable computer programs such as the network toolkit 45.

The network toolkit 45 can be a single computer program or a combination of two or more discrete computer programs that are associated by an administrative computer program that provides a single interface for access to the various discrete programs that comprise the network toolkit 45. Advantageously, the network toolkit 45 is accessible by a wireless communication device such as handset 12 via a wireless communication network. The toolkit 45 can preferably be optimized to execute in such a networked embodiment. Moreover, the toolkit 45 can preferably be optimized to service a plurality of handsets at any given time.

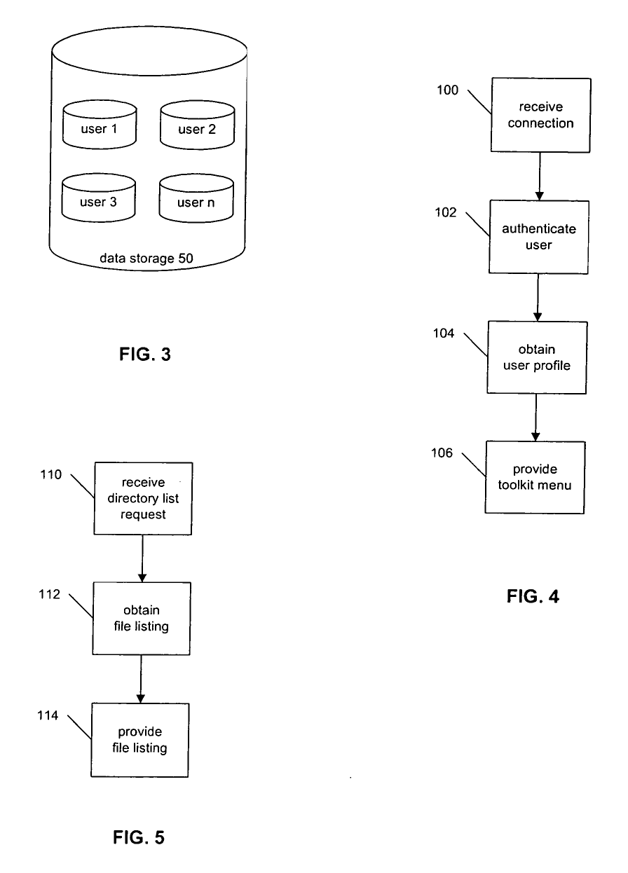

FIG. 3 is a block diagram of an example data storage area 50 that can be used in a wireless connectivity toolkit system. The data storage area 50 can be comprised of a plurality of discrete user storage areas such as user storage area 1, user storage area 2, user storage area 3, and user storage area n. In the illustrated embodiment, user storage area n is shown to emphasize that more than four user storage areas can be present in a wireless connectivity toolkit system.

The data storage area 50 can be implemented in a variety of ways, for example a standard database can be employed. Alternatively, a file system structure can be used as data storage area 50, with separate directories for each of the discrete user storage areas such as user storage area 1, user storage area 2, and user storage area 3 (and up to and including user storage area n). Other types of data storage solutions may also be employed, as will be understood by those having skill in the art.

FIG. 4 is a flow diagram illustrating an example process for connecting to a wireless connectivity toolkit server via a wireless communication network. Initially, in step 100, the toolkit server receives a connection from a handset. The connection arrives at the toolkit server by way of a wireless communication network. Upon receiving the connection request, the toolkit server may authenticate the handset, as illustrated in step 102. Authentication may include validation of the phone number associated with the handset or a more comprehensive scheme of user name and password validation. Additionally, the authentication step may not be required.

In step 104, the toolkit server obtains the profile information for the connecting handset. Profile information may include, for example, information such as the data storage capability of the handset, the communication speed of the handset, and the discrete data storage area associated with the particular handset. Additional profile information may include account status for the handset, for example, whether the account for the particular handset is current or in arrears with respect to any service or account related fees.

Once the profile information is obtained, the toolkit server provides the toolkit menu to the handset in step 106. The menu is provided to the handset via the wireless communication network. In one embodiment, the toolkit menu can be provided in a compressed format that is expanded by the handset upon receipt. Such an embodiment advantageously minimizes data transfer over the wireless communication network. At the handset, upon receipt of the toolkit menu, the handset preferably displays the menu for interaction with and use by the user.

FIG. 5 is a flow diagram illustrating an example process for obtaining a file list from a wireless connectivity toolkit server. Initially, in step 110, the toolkit server receives a request for a directory listing. Such a request can preferably be initiated by a user making a selection from the toolkit menu.

In one embodiment, a user has a discrete user storage area and a request for a directory listing is requesting a listing of the contents of the particular user's storage area. For example, a user may have various files in the storage area, including audio files that can be used as custom ringers or image files that can be used as backgrounds for the handset screen. Additional files can also be present in the user storage area such as video and text files. In an alternative embodiment, the storage area can advantageously be accessed both by the handset via the wireless communication network and also by a computer or other network enabled device via a private or public network such as the internet.

Once the toolkit server has received the directory listing request, the server obtains the file listing as illustrated in step 112. The file listing may be obtained through a database query or through a command issued to the operating system of the server. For example, if the data storage area is implemented as a file system, then the toolkit server can issue a command to the operating system of the server computer and receive the file listing as a result of that command.

In step 114, the toolkit server provides the file listing to the requesting handset via the wireless communication network. Preferably, upon receipt of the file listing, the handset displays the file listing to the user.

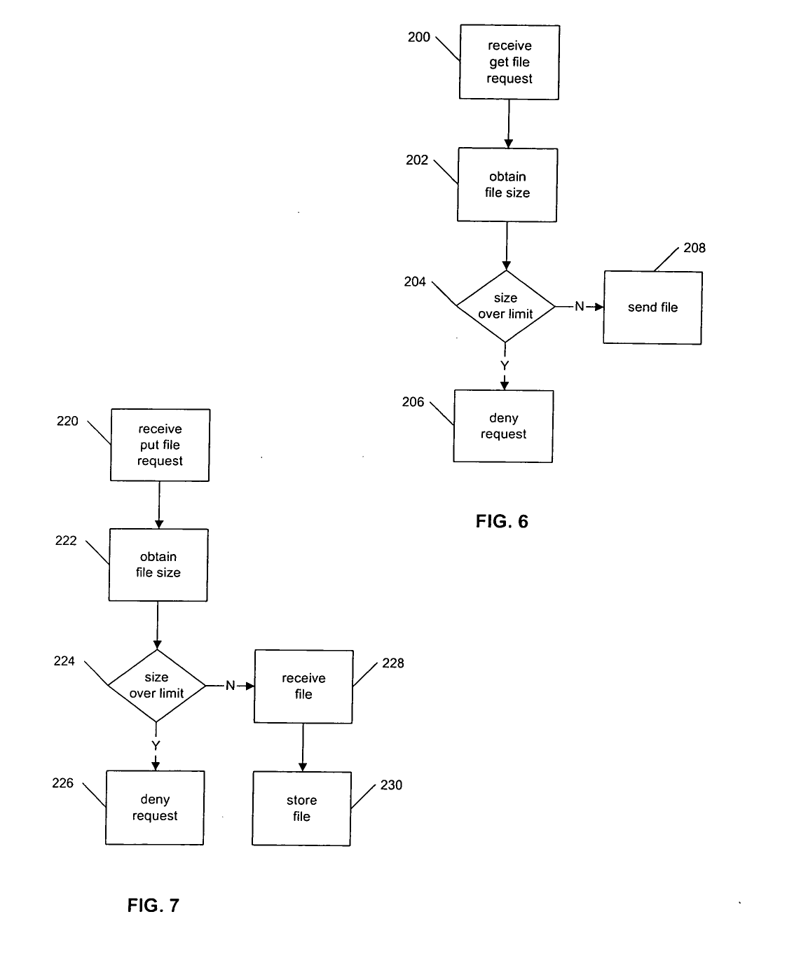

FIG. 6 is a flow diagram illustrating an example process for downloading a file from a wireless connectivity toolkit server. Initially, in step 200, the toolkit server receives a get file request. Preferably, the get file request contains enough information to uniquely identify the file. For example, the information in the get file request may include a filename with the full directory path. Alternatively, the information in the get file request may include an inode number that uniquely identifies the file in a file system. The information in the get file request may also be an index into a database record that either contains the file or contains a reference to the file. In one embodiment, the get file request contains a unique file identifier that was provided to the handset by the toolkit server in the context of a directory listing.

Once the toolkit server has received a get file request, the server then determines the size of the requested file, as illustrated in step 202. The size of a particular file may be obtained by the toolkit server in a similar fashion as the directory listing. For example, the server may obtain the information from a database. Alternatively, the server can request the file size information from the operating system of the server computer.

After obtaining the file size of the requested file, the toolkit server next can compare the file size to a predetermined threshold file size, as shown in step 204. Advantageously, this allows a user or the network administrators to set a maximum file size for uploads and downloads. Such a file transfer policy can facilitate multi-user usage of the toolkit server by not allowing a single user to overtax the toolkit server's file transfer resources and the network bandwidth. If the result of the comparison indicates that the file is over the predetermined threshold limit for file transfers (i.e., the file is too big), then the get file request is denied in step 206. If, however, the result of the comparison indicates that the file is not too big, then in step 208 the toolkit server sends the file to the requesting handset.

In an alternative embodiment, the file size threshold may not be set and the toolkit server may send the file to the requesting handset upon receiving the get file request. In such an embodiment, the network provider may charge users, in part, by the number of megabytes transferred over the wireless communication network. Thus, users are free to transfer any size file and no restrictions are imposed by the toolkit server or the network.

FIG. 7 is a flow diagram illustrating an example process for uploading a file to a wireless connectivity toolkit server. Initially, in step 220, the toolkit server receives a put file request. Preferably, the put file request contains information about the file to be uploaded to the toolkit server. For example, the information in the put file request may include a filename, file size, and file type, along with other helpful information about the requested upload. In one embodiment, the file type may indicate whether the file is an audio file, a graphic file, a video file, or a text file. Moreover, the toolkit server may require certain information as part of a valid put file request. For example, a put file request may be invalid if it does not identify the file name of the file to the uploaded to the toolkit server.

Once the toolkit server has received a put file request, the server then determines the size of the requested file, as illustrated in step 222. For example, the toolkit server may parse the put file request to obtain the size of the file to be uploaded to the toolkit server. After obtaining the file size of the file to be uploaded, the toolkit server next can compare the file size to a predetermined threshold file size, as shown in step 224. Advantageously, this allows a user or the network administrators to set a maximum file transfer size for uploads and downloads as previously described. If the result of the comparison indicates that the file is over the predetermined threshold limit for file transfers (i.e., the file is too big), then the put file request is denied in step 226. If, however, the result of the comparison indicates that the file is not too big, then in step 228 the toolkit server receives the file from the requesting handset.

Once the toolkit server has received the file, the file can be stored in a data storage area, as illustrated in step 230. For example, the file may be stored in a discrete portion of a data storage area that is associated with the particular handset that uploaded the file (e.g., a user directory). Alternatively, the file may be stored as part of a database that houses information and files for all of the handsets that use the wireless connectivity toolkit server.

In an alternative embodiment, the file size threshold may not be set and the toolkit server may receive the file from the requesting handset as part of the put file request or immediately thereafter. In such an embodiment, the network provider may charge users, in part, by the number of megabytes transferred over the wireless communication network. Thus, users are free to transfer any size file and no restrictions are imposed by the toolkit server or the network.

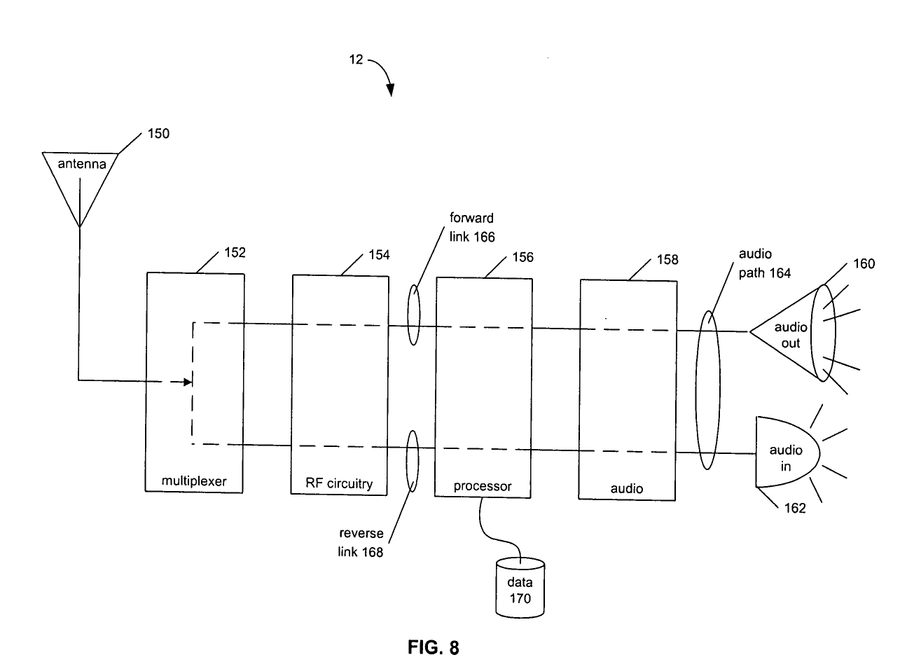

FIG. 8 is a block diagram illustrating an example wireless communication device 12 as may be used in connection with various embodiments described herein. Wireless communication device 12 comprises an antenna 150, a multiplexer 150, RF circuitry 154, a processor 156, audio circuitry 158, a speaker 160, and a microphone 162. Wireless communication device 12 also has an audio path 164 that comprises a forward link 166 and a reverse link 168. Additionally, wireless communication device 12 also has a data storage area 170.

The components of device 12 work in concert to facilitate wireless communication over a wireless communication network (not shown). Generally, multiplexor 152 combines and separates the signals in the audio path 164. The RF circuitry 154 modulates and demodulates the audio signals in the audio path 164. The processor 156 encodes and decodes the audio signals in the audio path 164. The processor 156 additionally may handle the user interface and other functions of the wireless communication device, including managing the data storage area 170. The audio circuitry 158 performs analog to digital conversion for audio signals in the reverse link 168 and also performs digital to analog conversion for audio signals in the forward link 166.

The workings of the various components of device 12 are well known in the art and the illustrated functional components can be implemented in a variety of physical combinations, for example, the audio conversion function can be integrated into the processor 156. The various alternative implementations of the wireless communication device 12 are all contemplated to work with the claimed invention. Thus, the illustrated embodiment of wireless communication device 12 shall not be construed to limit the claimed invention in any fashion.

The antenna 150 is adaptable to receive wireless communication signals in the conventional fashion. Advantageously, the wireless communication signals may be for both voice and data services. Similarly, the speaker 160 and the microphone 162 are adaptable to provide and receive analog audio signals in the conventional fashion. The forward link 166 of the audio path 164 is the audio channel for incoming audio. Audio signals on the forward link 166 typically include those audio signals that are received by the antenna 150. The reverse link 168 of the audio path 164 is the audio channel for outgoing audio. Audio signals on the reverse link 168 typically include those audio signals that are received by the microphone 162.

Data signals received by the antenna 150 are preferably provided to the processor 156 via the forward link 166. Similarly, data signals that are destined for a remote device are preferably sent to the antenna 15 from the processor 156 over the reverse link 168.

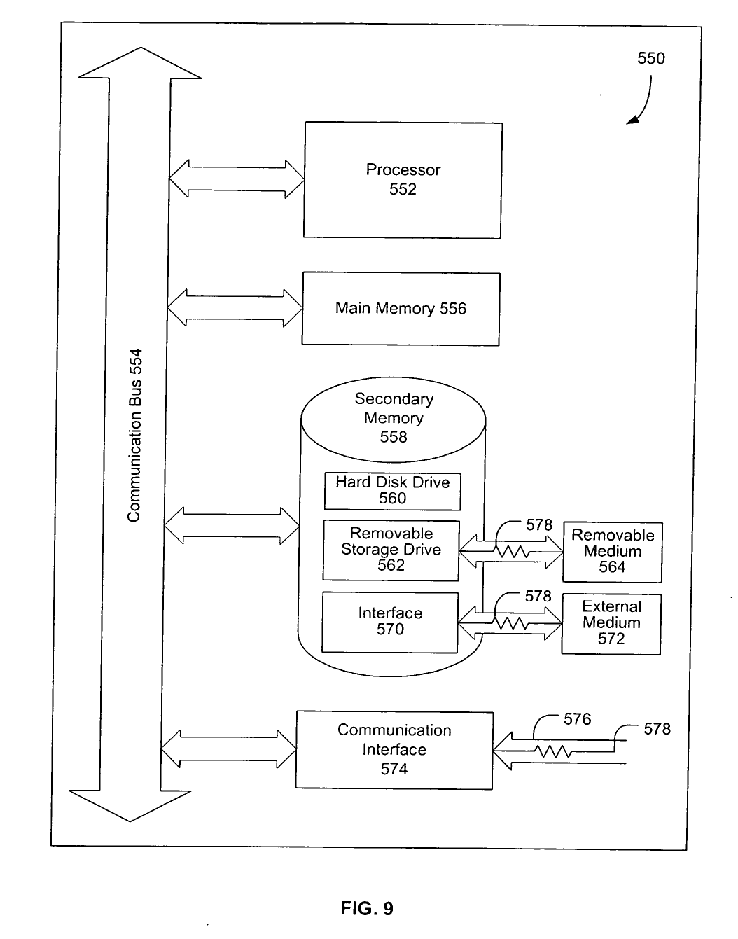

FIG. 9 is a block diagram illustrating an exemplary computer system 550 that may be used in connection with the various embodiments described herein. For example, the computer system 550 may be employed as a wireless connectivity server. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

While the particular system and method for a wireless connectivity toolkit herein shown and described in detail is fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for providing a connectivity toolkit to a wireless communication device coupled with a connectivity toolkit server via a wireless communication network, the method comprising:
receiving a wireless data connection from a wireless communication device;
authenticating a user associated with the wireless communication device; and
providing a menu of available connectivity toolkit utilities, wherein the menu is displayed on the wireless communication device.

2. The method of claim 1, further comprising:
receiving a request for a directory listing;
obtaining a list of files associated with the requesting user; and
providing the list of files, wherein the list of files is displayed on the wireless communication device.

3. The method of claim 2, wherein the obtaining step further comprises:
querying a file system on the connectivity toolkit server to determine a list of user files; and
identifying a user file associated with the requesting user.

4. The method of claim 1, further comprising:
receiving a request to download a file, the request comprising a file identifier;
obtaining the file size of the requested file;
comparing the file size to a predetermined threshold file size value; and
denying the request to download the file when the file size exceeds the predetermined threshold file size value.

5. The method of claim 1, further comprising:
receiving a request to download a file, the request comprising a file identifier;
obtaining the file size of the requested file;
comparing the file size to a predetermined threshold file size value;
approving the request to download the file when the file size is smaller than the predetermined threshold file size value; and
providing the requested file via a wireless communication network.

6. The method of claim 1, further comprising:
receiving a request to upload an identified file, the request comprising a filename and a file size;
comparing the file size to a predetermined threshold file size value;
approving the request to upload the file when the file size is smaller than the predetermined threshold file size value; and
receiving the identified file via a wireless communication network.

7. A wireless connectivity toolkit system, comprising:
a wireless connectivity toolkit server having a data storage area and a plurality of utility programs, the toolkit server communicatively coupled with a wireless communication network;
a wireless communication device communicatively coupled with the wireless connectivity toolkit server via the wireless communication network, wherein the wireless communication device establishes a session with the wireless connectivity toolkit server over the wireless communication network, the session allowing execution of the utility programs.

8. The wireless connectivity toolkit system of claim 7, wherein the plurality of utility programs comprises a file transfer program.

9. The wireless connectivity toolkit system of claim 8, wherein the file transfer program facilitates the transfer of files between the wireless communication device and the wireless connectivity toolkit server.

10. The wireless connectivity toolkit system of claim 7, wherein the data storage area coupled with wireless connectivity server provides data storage for a plurality of wireless communication devices, the data storage accessible to the plurality of wireless communication devices via the wireless communication network.

11. The wireless connectivity toolkit system of claim 10, wherein the network based data storage is provided to a wireless communication device for a fee.

12. The wireless connectivity toolkit system of claim 11, wherein the fee is based on the total amount of data storage in use by the wireless communication device.

13. The wireless connectivity toolkit system of claim 11, wherein the fee is based on the total amount of data storage available for use by the wireless communication device.

14. A computer readable medium having stored thereon one or more sequences of instructions for causing one or more microprocessors to perform certain steps to provide a wireless connectivity toolkit to a wireless communication device, the steps comprising:
receiving a wireless data connection from a wireless communication device;
authenticating a user associated with the wireless communication device; and
providing a menu of available connectivity toolkit utilities, wherein the menu is displayed on the wireless communication device.

15. The computer readable medium of claim 14, further comprising:
receiving a request for a directory listing;
obtaining a list of files associated with the requesting user; and
providing the list of files, wherein the list of files is displayed on the wireless communication device.

16. The computer readable medium of claim 15, wherein the obtaining step further comprises:
querying a file system on the connectivity toolkit server to determine a list of user files; and
identifying a user file associated with the requesting user.

17. The computer readable medium of claim 14, further comprising:
receiving a request to download a file, the request comprising a file identifier;
obtaining the file size of the requested file;
comparing the file size to a predetermined threshold file size value; and
denying the request to download the file when the file size exceeds the predetermined threshold file size value.

18. The computer readable medium of claim 14, further comprising:
receiving a request to download a file, the request comprising a file identifier;
obtaining the file size of the requested file;
comparing the file size to a predetermined threshold file size value;
approving the request to download the file when the file size is smaller than the predetermined threshold file size value; and
providing the requested file via a wireless communication network.

19. The computer readable medium of claim 14, further comprising:
receiving a request to upload an identified file, the request comprising a filename and a file size;
comparing the file size to a predetermined threshold file size value;
approving the request to upload the file when the file size is smaller than the predetermined threshold file size value; and
receiving the identified file via a wireless communication network.
